(19) United States
(12) Patent Application Publication
(10) Pub. No.: US 2005/0146139 A1
(43) Pub. Date: Jul. 7, 2005

(54) Flange connection and method for producing it

(75) Inventors: Dirk Huybrechts, Heidelberg (DE); Hans-Werner Schwiderski, Norten-Hardenberg (DE); Paul Szasz, Plankstadt (DE)

Correspondence Address: BURNS DOANE SWECKER & MATHIS L L P, POST OFFICE BOX 1404, ALEXANDRIA, VA, 22313-1404, US

(73) Assignee: ABB Patent GmbH, Ladenburg (DE)

(21) Appl. No.: 10/996,386

(22) Filed: Nov. 26, 2004

(30) Foreign Application Priority Data
Nov. 26, 2003 (DE) 103 55 848.9

(51) Int. Cl. F16L 21/02

(52) U.S. Cl. 285/368; 285/414

(57) ABSTRACT

The invention relates to a flange connection, in particular for connecting the measuring pipe (6) of a measuring device for fluid substances to a process pipeline (4), comprising a flange disc on the device side (22) and a flange disc on the line side (22a), the flange disc on the device side (22) having an inner circumferential surface (24) and an outer circumferential surface, and it being possible for the pipe wall of the measuring pipe (6) to be formed, at least at the end zone of the pipe (8), by layers of different materials lying one on top of the other, and is characterized in that the pipe wall of the measuring pipe (6) has a radially outwardly pointing formation (12) at the end zone of the pipe (8), and in that in the installed state axial tensile forces can be transmitted from the flange disc on the device side (22) to the measuring pipe (6) via the formation (12).

### DESCRIPTION

The invention relates to a flange connection, in particular for connecting the measuring pipe of a measuring device to a process pipeline of a process engineering process, according to the precharacterizing clause of claim 1, and also to a method for producing a flange connection according to the precharacterizing clause of claim 27.

A flange connection of the generic type according to the current state of the art comprises a flange disc on the device side, i.e. firmly attached to the measuring pipe, and a flange disc on the line side, i.e. firmly attached to the process pipeline. The two flange discs are usually pressed against each other by means of clamping screws and braced in such a way that axial forces are exerted on the measuring pipe. As a result, the end of the measuring pipe is pressed against the end of the process pipe and the two are braced in such a way that the measuring pipe is then connected to the process pipe in a fluid-tight manner by means of a sealing surface located between the end of the measuring pipe and the end of the line pipe. The flange discs each have an inner circumferential surface and an outer circumferential surface; they are firmly connected by the inner circumferential surface to the pipe end respectively assigned to them, for example screwed, welded or soldered on, etc.

Measuring pipes which are used in today's measuring devices are often made of steel or some other metal. However, flowmeters with measuring pipes made of plastic or ceramic are also generally known. Measuring pipes which are formed, at least at the end zones of the pipe, by layers of different materials lying one on top of the other, for example comprising a metal core with plastic sheathing, have also been proposed.

A flange connection of the generic type is used for example for incorporating a flowmeter in the process pipeline in which the through-flow is to be determined.

In the case of metal measuring pipes, the fastening of the flange disc on the device side usually takes place by a welded connection. In the case of measuring devices with measuring pipes which do not consist of metal, it is either necessary to revert to intermediate-flange mounting, known as wafer mounting, in which the measuring pipe does not have any flange of its own but is attached between two flanges attached to the ends of the process pipeline, and the bracing takes place between these two flanges, or else a flange is attached to the non-metal pipe in a very complex manner.

The attaching of the flange or flanges to the measuring pipe must in this case take place already at the beginning of the sequence of operations involved in producing a flowmeter. This is so because flowmeters are always constructed in such a way that all the necessary subsystems, such as the signal pickup, magnetic system, housing, electrical connection device and transmitter, are attached to the measuring pipe. The high-temperature processes (welding, soldering, ceramic-metal connection, etc.) that are necessary according to the current state of the art for fastening the flange to the measuring pipe would have a harmful effect on the often sensitive and very accurately adjusted subsystems, for which reason this production step is at the beginning of the production process.

At the same time, the users of flowmeters today expect the manufacturers of the devices to offer a large number of device variants with regard to the type of flange connection (flange diameter, number and diameter of the screw holes, etc.) for each pipe width. For the manufacturers, this has the consequence that they have to keep a number of different prefabricated measuring pipe/flange combinations in stock, which makes stockkeeping more expensive.

It is therefore the object of the present invention to provide a flange connection of the generic type which can be easily produced and handled and which eliminates the disadvantages of the flange connections known in the prior art.

The object is achieved with regard to the flange connection by the characterizing features of claim 1 and with regard to the method of producing it by the characterizing features of claim 27.

According to the invention, therefore, the pipe wall of the measuring pipe has a region of greater outside diameter at the end zones of the pipe than in the middle zone of the pipe, which is also referred to hereafter as the widening region, with a flank rising towards the pipe end, and in the installed state axial forces can be transmitted from the flange disc on the device side to the end of the measuring pipe via the widening region.

In the case of a flange connection according to the invention, therefore, axial tensile forces are normally introduced into a force introduction region at the end of the pipe from the flange disc on the device side. As a result, the end of the pipe is pressed against the opposing end of the process pipe for the purpose of pipe connection.

In an advantageous refinement of the invention, the pipe wall of the measuring pipe may have in the widening region a radially outwardly pointing formation, which may advantageously be formed as a bead with a flank rising continuously towards the end of the pipe. This means that the pipe inside diameter at the end of the pipe remains unchanged in comparison with the middle of the pipe, but the pipe outside diameter increases continuously towards the end of the pipe, so that the total pipe wall thickness, determined as the difference between the pipe outside diameter and the pipe inside diameter, increases towards the end of the pipe. The radial formation may in this case be formed by applying fibre composite material layer by layer, for example by a winding-on technique or some other known technique of building up layers. The application of the formation by means of fibre composite materials otherwise takes place by using methods known in fibre composite material technology for producing components.

In another very advantageous refinement of the invention, the measuring pipe may also be widened in the widening region at the end of the pipe in such a way that a flank rising continuously towards the end of the measuring pipe is formed by the widening. In this embodiment, the pipe wall thickness, determined as the difference between the pipe outside diameter and the pipe inside diameter, remains unchanged towards the end of the pipe. On the other hand, the pipe inside diameter and the pipe outside diameter become greater towards the end of the pipe.

The advantage of the solution according to the invention is that only in the installed state is there a firm connection between the flange disc and the measuring pipe, produced by non-positive and positive engagement. In this case, axial tensile forces are transmitted from the flange disc to the measuring pipe via the radial formation, and, as mentioned at the beginning, the measuring pipe is firmly braced by the flange disc with the mating flange that is on the process pipe.

Therefore, the installed state is in this sense that state in which the flange on the device side is connected to the flange on the process pipe side by means of the usual clamping devices. Only in this installed state is there a positive, and consequently fluid-tight, connection between the flange on the device side and the flange on the process side.

In the non-installed state, the flange disc can rest loosely on the formation, or else be kept at any desired position on the end of the measuring pipe. In any event, the flange disc need not be firmly connected to the measuring pipe already at the beginning of the production process.

This type of flange connection according to the invention is similar to a known connection referred to as a loose-flange connection. In this case, if it is resting on the formation before completion of the flange connection, the flange disc has in each case two degrees of freedom, that is a movement in the axial direction and a movement in the radial direction. The axial movement towards the end of the pipe is blocked by the radially rising formation. The axial movement in the direction away from the end of the pipe and the radial movement are not blocked however. As a mounting aid, the flange disc can therefore be kept in a predetermined position by auxiliary mounting means before the firm flange connection is produced.

A particularly favourable configurational variant of the invention is characterized in that, for the force transmission, an intermediate piece which is in connection with the flank of the radial formation, at least in certain portions, is arranged between the flange disc and the formation. In the installed state, there is then a positive and/or non-positive connection between the flange disc and the formation or between the intermediate piece and the formation. In a further preferred embodiment, the intermediate piece is of a multipart configuration.

The use of an intermediate piece in the configurational variant just described has the great advantage that a customary standard part can be used as the flange disc. In particular, however, the flange disc, and the intermediate piece if required, can be attached as the last step in the sequence of operations involved in producing the measuring device. For example, the formation may be attached to the end or ends of the measuring pipe already at the beginning of the production process. Then, all the further subsystems are attached to the measuring pipe in the usual way, until the measuring device is finished. Only then is the flange ring pushed over. The inside diameter of the flange ring is then of course greater than the greatest outside diameter of the measuring pipe with the formation attached. The intermediate piece may for example comprise two half-shells, which are attached from the sides to the end of the measuring pipe and made to engage with each other, to be precise in such a way as to produce an annular intermediate piece with an inside diameter which is greater than the diameter of the measuring pipe, but less than the diameter of the formation. Then the flange disc is braced in the way described above.

Consequently, the variational diversity provided by the different types of flange is only introduced at the end of the production process. This allows the stockkeeping for the measuring pipes to be restricted to a limited number of measuring pipes of different nominal diameters. Only when the measuring device is finished is the desired flange/pipe combination produced by adding the respectively desired flange disc. The adaptation of the inside diameter of the flange disc to the outside diameter of the measuring pipe with the formation can take place, if required, by means of the intermediate piece.

It is also possible, however, for the measuring pipe with the widening region to be formed entirely or partly from fibre composite material or from metal.

Alternatively, the measuring pipe could also be formed as a metal part and the widening region could be formed entirely or partly from fibre composite material.

Advantageously, to achieve a particularly good force transmission between the flange disc and the measuring pipe, the longitudinal sectional contour of the inner circumferential surface of the flange disc or of the intermediate piece is adapted to the circumferential contour of the measuring pipe in the widening region.

The longitudinal section of the outer circumferential contour of the measuring pipe in the widening region may in this case advantageously correspond to a polynomial of the nth degree, n being an integral number, in particular between 0 and 10, preferably between 0 and 4 and particularly preferably 1 or 2 or 3. If n=1, a polynomial of the first degree or a straight line is obtained. A circumferential contour of which the longitudinal section corresponds to a straight line is a conical circumferential contour. If n=2, a polynomial of the second degree or a parabola is obtained. The circumferential contour in the widening region then has a parabolic longitudinal section. If n=−1, a hyperbola is obtained. A circumferential contour of which the longitudinal section corresponds to a hyperbola is a hyperboloid.

The sealing surface between the measuring pipe and the process pipe may be configured either with or without an additional sealing ring. The widening region may be formed in such a way that a second flank, which faces towards the end of the measuring pipe, lies in the plane defined by the end of the measuring pipe and consequently forms together with the end of the measuring pipe an enlarged sealing surface.

In order to increase the ease with which installation is performed, the intermediate piece and/or the flange disc may be temporarily held in their installation position before installation by suitable mounting means, for example spots of adhesive and/or mechanical holding aids and/or by wrapping with fibre composite material.

The mating flange on the process pipe side may either be welded on in a conventional manner, or it is likewise configured in the manner according to the invention.

Further advantageous refinements and improvements of the invention and further advantages can be taken from the further subclaims.

The invention and further advantageous refinements and improvements of the invention as well as further advantages are to be explained and described on the basis of the drawings, in which three exemplary embodiments of the invention are represented and in which:

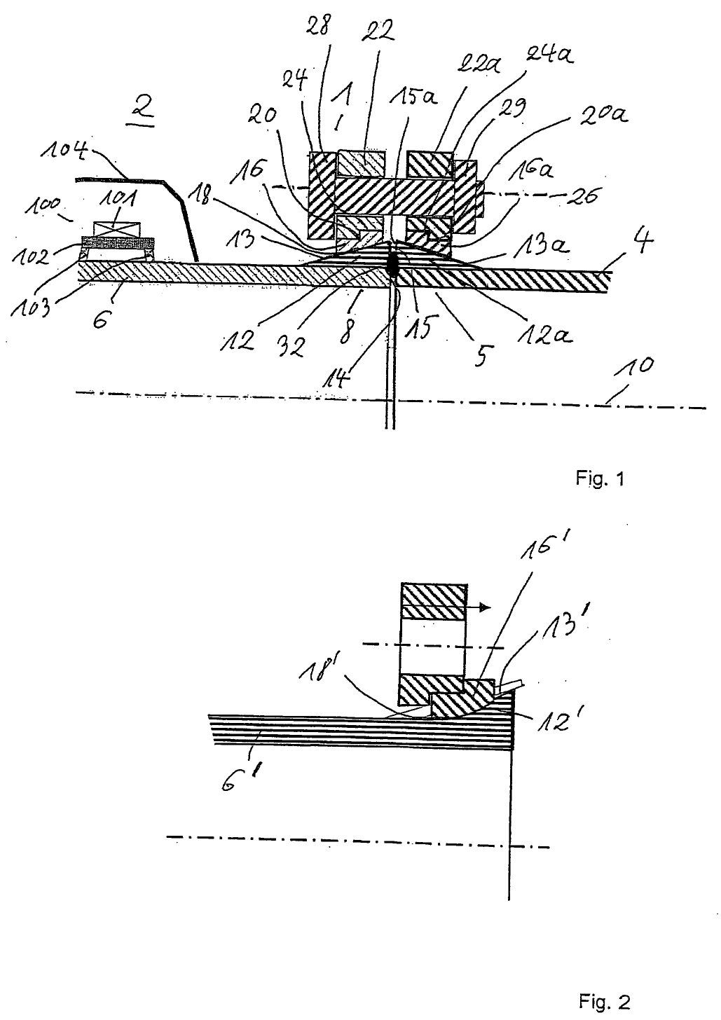

FIG. 1 shows a first embodiment of a flange connection according to the invention with a conical formation,

FIG. 2 shows a second embodiment of a flange connection according to the invention with a hyperbolic formation,

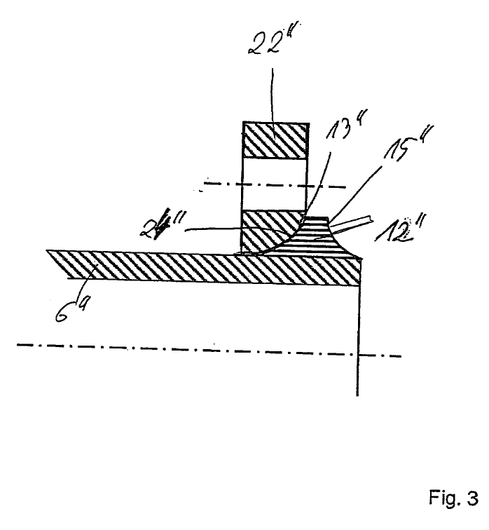

FIG. 3 shows a third embodiment of a flange connection according to the invention with a bead-shaped formation,

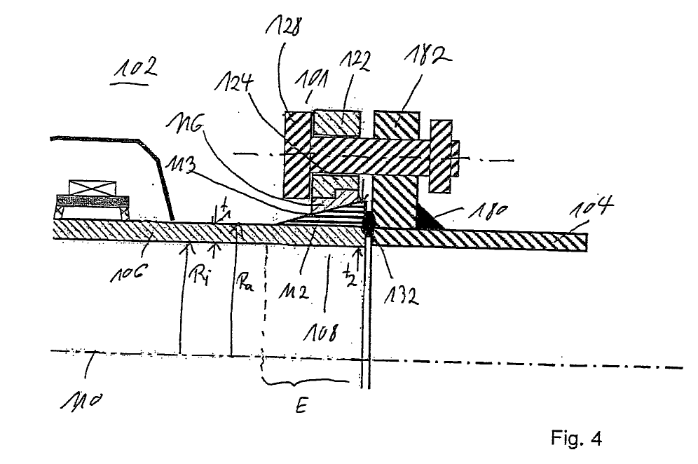

FIG. 4 shows a fourth embodiment of a flange connection according to the invention with a mating flange welded on on the process pipe side in a conventional manner, and

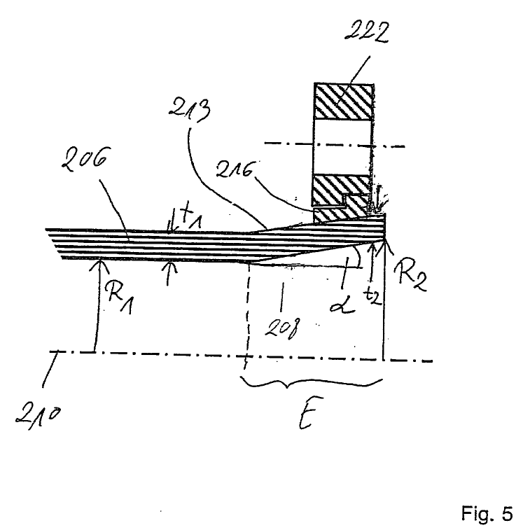

FIG. 5 shows a fifth embodiment of the invention, with a conical widening of the measuring pipe at the end of the measuring pipe.

FIG. 1 shows, in the left-hand part in longitudinal section, a part of a flowmeter 2, which is connected to a process pipe 4 via a flange connection 1 according to the invention. The flowmeter, the pipelines and the flange connection are formed rotationally symmetrically, indicated by the centre line 10, which is at the same time the line of symmetry.

The flowmeter is formed as a magnetic-inductive flowmeter. It comprises a measuring pipe 6, to which the further subsystems are attached. In FIG. 1, not all these subsystems are shown for reasons of overall clarity; only the magnetic system 90 with the excitation coil 91 and the ferromagnetic core 92, which are mounted together on the wall of the measuring pipe by means of conventional connecting elements 93, and the housing 94 are represented. The measuring pipe 6 consists of metal; as is customary in the prior art, it consists of high-grade steel. It has an inner radius Ri, which is approximately constant over the entire length of the pipe, and an outer radius Ra. The pipe wall thickness is determined by the difference between the inner radius Ri and the outer radius Ra.

At the end 8 of the measuring pipe 6, in a widening region E, the pipe wall of the measuring pipe 6 has a conical formation 12. It points radially outwards, and has a sawtooth-shaped longitudinal sectional contour with a gently rising first flank 13 and a steeply falling second flank 15. The steep flank 15 of the formation 12 that is pointing towards the end of the pipe 8 forms together with the end of the pipe 8 a sealing surface 14. The formation 12 was produced by winding a fibre composite material onto the end piece of the measuring pipe 6 and subsequently smoothing the flanks 13, 15 by one of the methods known in the prior art for producing components from fibre composite material, which need not be described here.

The formation 12 has the effect that the effective pipe wall thickness t2 in the widening region, determined as the difference between the effective pipe outer radius, that is the distance between the centre line and the outer surface of the formation 12, and the pipe inner radius Ri, is greater than the pipe wall thickness t1 outside the widening region E. t2 increases continuously, starting from a value t1 at the beginning of the widening region E on the device side, towards the end of the pipe, the longitudinal section of the outer circumferential contour of the measuring pipe corresponding in the widening region E to a polynomial of the first degree, that is a straight line with a positive slope towards the end of the pipe.

The process pipe 4 is also a metal pipe. Its nominal diameter is adapted to the nominal diameter of the measuring pipe 6. A conical formation 12a with a sawtooth-shaped longitudinal sectional contour, comprising a first, gently rising flank 13a and a second flank 15a, falling steeply towards the end of the pipe, is also applied to the end piece 5 of the process pipe 4, likewise by winding on fibre composite material and subsequent smoothing of the flanks.

In positive and non-positive contact with the formation 12 of the measuring pipe 6, an annular intermediate piece 16 bears with its inner circumferential surface 18 against the first flank 13. The longitudinal sectional contour of the inner circumferential surface 18 of the intermediate piece 16 is adapted to the longitudinal sectional contour of the first flank 13 of the formation 12. The outer circumferential surface 20 of the intermediate piece 16 has a step-shaped longitudinal sectional contour.

A flange disc 22 bears with its inner circumferential surface 24 against the outer circumferential surface 20 of the intermediate piece 16, in positive and non-positive connection. The longitudinal sectional contour of the inner circumferential surface 24 of the flange disc 22 is adapted to the step-shaped longitudinal sectional contour of the outer circumferential surface 20 of the intermediate piece 16.

In an analogous way, an intermediate piece 16a and a flange disc 22a are attached to the end piece 5 of the process pipe 4. Bores for receiving the clamping screws 28 are provided in the flange discs 22, 22a in the conventional way. In FIG. 1, only one such bore is represented, indicated by its centre line 26. Usually, at least two, mostly four, six or eight bores are provided, with the corresponding number of clamping screws. The clamping screw 28 is screwed with a lock nut 29.

Attached to the sealing surface 14 between the two ends of the pipes is a sealing ring 32, which makes it easier to produce a fluid-tight pipe connection. If the sealing surfaces, formed by the ends of the pipes and the steep flanks 15, 15a of the formations 12, 12a are configured smooth enough, it is also possible if required to dispense with the sealing ring 32 and nevertheless produce a fluid-tight pipe connection.

The function and production of the flange connection that is shown in FIG. 1 is as follows:

The formation 12 on the measuring pipe 6 is attached to the end 8 of the measuring pipe already at the beginning of the production process. Then, all the further subsystems are attached to the measuring pipe in the customary way, until the measuring device is finished. Only then is the flange ring 22 pushed over. The inside diameter of the flange ring 22 is then of course greater than the greatest outside diameter of the measuring pipe with the attached formation 12. The intermediate piece 16 may comprise, for example, two half-shells, which are attached to the end 8 of the measuring pipe from the sides and made to engage with each other, to be precise in such a way that the annular intermediate piece 16 is produced with an inside diameter which is greater than the diameter of the measuring pipe, but less than the diameter of the formation.

The formation 12a at the end of the process pipe may also have already been attached during the production of the process pipe, or it is only wound on in the installation position. The intermediate piece 16a on the process pipe side is formed in the same manner as the intermediate piece 16 on the measuring pipe side. Both may consist of metal or else again of fibre composite material. After their attachment, they still rest loosely on the first flanks 13, 13a of the two formations 12, 12a, but may also have already been attached in a positive and/or non-positive connection.

Even before applying the intermediate pieces 16, 16a, the flange discs 22, 22a were pushed onto the ends of the measuring pipe 6 and the process pipe 4, respectively. They rest loosely and can easily be displaced. Their form, in particular outside diameter, thickness and number and diameter of the bores, is chosen and produced customer-specifically.

For the completion of the flange connection, the two flange discs are brought into their installation position, so that their inner circumferential surfaces 24, 24a bear with positive engagement against the outer circumferential surfaces 20, 20a of the intermediate pieces 16, 16a. Then, the clamping screws 28 are inserted and the two flange discs are pressed against each other by means of the screws and braced with the lock nuts 29 in such a way that axial forces acting on the measuring pipe 6 and the process pipe 4 are exerted in opposite directions. As a result, the end of the measuring pipe is pressed against the end of the process pipe and the two are braced in such a way that the measuring pipe 6 is then connected to the process pipe 4 in a fluid-tight manner by means of the sealing surface 14 located between the end of the measuring pipe and the end of the line pipe.

FIG. 2 shows a further embodiment of a flange connection according to the invention. Identical, similar or equivalent parts are provided with the same reference numerals as in FIG. 1, supplemented by a superscript apostrophe. Only the part of the flange connection that is located on the measuring pipe 6′ is shown; the counterpart, located on the process pipe, may be configured in an analogous way or else conventionally by a welded-on flange or in the manner shown in FIG. 1. The embodiment that is shown in FIG. 2 differs from that of FIG. 1 in that the longitudinal sectional contour of the gently rising first flank 13′ of the formation 12′ is hyperbolically formed. In a corresponding way, the inner circumferential surface 18′ of the intermediate piece 16′ is adapted to this hyperbolic longitudinal sectional contour, so that the two fit into each other again during bracing—like a key into a lock—and consequently a positive and non-positive connection can be produced for the transmission of the axial forces. The hyperbolic longitudinal sectional contour has the advantage that the distribution of forces can be set in an optimized way.

A further difference between FIGS. 2 and 1 is that, in the embodiment that is shown in FIG. 2, the measuring pipe 6′ with the formation 13′ on the end of the measuring pipe was constructed completely in one production operation from fibre composite material and was produced for example by a winding technique.

The measuring pipe 6′ with the formation 13′ could also be a cast part, and the formation 13′ could have been cast on directly with it during casting. Similarly, instead of a hyperbola shape, some other shape of curve could be chosen for the longitudinal sectional contour of the formation 13′.

FIG. 3 shows a third embodiment of a flange connection according to the invention. Identical, similar or equivalent components are provided with the same reference numerals as in FIG. 1, supplemented by two superscript apostrophes. The formation takes the form of a bead 13″ with a table-mountain-like longitudinal sectional contour, wound up onto the end piece of the measuring pipe 6″ of fibre composite material and provided with two flanks 13″ and 15″, which both have a hyperbolic longitudinal cross-sectional contour. In the case of the flange connection that is shown in FIG. 3, the inner circumferential surface 24″ of the flange disc 22″ is formed in such a way that its longitudinal sectional contour is adapted to that of the hyperbolic longitudinal sectional contour of the rising flank 13″ of the bead 12″, so that the two fit into each other again during bracing—like a key into a lock—and consequently a positive and non-positive connection can be produced for the transmission of the axial forces.

FIG. 3 consequently shows a flange connection according to the invention without an intermediate piece. In the case of this embodiment, the flange disc must be pushed over the end of the measuring pipe before the bead 12″ is applied. This may happen either during production or subsequently, shortly before the measuring device is installed into the process pipeline.

FIG. 4 shows an embodiment of a flange connection according to the invention with a mating flange 182 on the process pipe side, welded onto the process pipe 104 in a conventional manner, so that a weld 180 is produced at the joint between the process pipe 104 and the mating flange 182. The part of the flange connection on the measuring pipe side is constructed in the same way as described in FIG. 1. Identical or equivalent components or subassemblies otherwise bear the same reference numerals in FIG. 4 as in FIG. 1, in each case increased by the value 100.

FIG. 5 shows a further embodiment of the invention, with a conical widening of the measuring pipe at the end of the measuring pipe. Identical, similar or equivalent components are provided with the same reference numerals as in FIG. 1, but increased by 200. Only the part of the flange connection that is located on the measuring pipe 206 is shown; the counterpart, located on the process pipe, may be configured in an analogous way or else conventionally by a welded-on flange or in the manner shown in FIG. 1.

The measuring pipe 203 is widened in a widening region E at the end of the measuring pipe 208 in such a way that a flank 213 rising towards the end 208 of the measuring pipe 206 is formed by the widening. The pipe wall thickness t2 in the widening region E is unchanged here in comparison with the pipe wall thickness t1 outside the widening region E. On the other hand, the pipe inside diameter becomes greater towards the end of the pipe. Outside the widening region E, the measuring pipe 206 has an inside diameter R1; towards the end of the widening region E, and consequently of the measuring pipe 206, the pipe inside diameter is widened to a value R2, where R2>R1.

The longitudinal section of the outer circumferential contour of the measuring pipe in the widening region E corresponds to a polynomial of the first degree, that is a straight line with a positive slope towards the end of the pipe. In the example that is shown in FIG. 5, a conical widening with a cone angle α is shown.

In the example that is shown in FIG. 5, the measuring pipe 206 with the widening region E is produced from a metal pipe, for example by a casting technique. The widening region E with the conical widening could, however, also be welded onto the measuring pipe 206 in a conventional manner. The measuring pipe 206 could also be produced together with the widening in the widening region E completely by a fibre composite technique, for example by winding on.

The embodiment that is shown in FIG. 5 may also be configured in terms of flow as a measuring pipe with an inlet region—this corresponds to the widening region E—and a constricted measuring zone—this corresponds to the measuring pipe region outside the widening region E. The process pipe, which is connected to the measuring pipe by means of the flange connection according to the invention that is shown in FIG. 5, has an inside diameter R2. The measuring zone therefore has a smaller inside diameter than the process pipe, hence use above of the term “constricted measuring zone”. If the measuring device is a flowmeter and the measuring pipe 206 in the embodiment that is shown in FIG. 5 is accordingly the measuring pipe of a flowmeter, a higher flow rate is imparted to the flowing medium in the measuring pipe than outside the measuring pipe in the process pipe as a result of the reduced measuring-pipe cross section. If the measuring device is a magnetic-inductive flowmeter, an increase in the flow rate in the measuring pipe has a positive effect on the measuring accuracy. In this way, an increased measuring accuracy would be obtained as a further advantage along with the simple configuration of the flange connection in the case of a flange connection according to the invention on the basis of the embodiment according to FIG. 5.

For technical flow-related reasons, an angle α of 16° is very favourable for a configuration of the invention according to FIG. 5. Other larger or smaller angles, for example 10°, 12°, 14°, 18°, 20°, 30°, would likewise be advantageous.

The exemplary embodiments described above do not constitute all possible embodiments of flange connections according to the invention. All further conceivable embodiments that are not described in detail here but arise as a result of combinations of the embodiments described here, or parts or individual features of various of the embodiments shown here, are therefore intended to be covered by the present application.

1. Flange connection, in particular for connecting the measuring pipe of a measuring device to a process pipeline comprising a flange disc on the device side and a flange disc on the line side, the flange disc on the device side having an inner circumferential surface and an outer circumferential surface, characterized in that the pipe wall of the measuring pipe has a region of increased outside diameter (widening region) at the end zone of the pipe, in comparison with the middle zone of the pipe, and with a flank rising towards the end of the measuring pipe, and in that in the installed state axial forces can be transmitted from the flange disc on the device side to the end of the measuring pipe via the widening region.

2. Flange connection according to claim 1, wherein the pipe wall of the measuring pipe has in the widening region a radially outwardly pointing formation.

3. Flange connection according to claim 1, wherein the radial formation is formed as a bead with a flank rising continuously towards the end of the measuring pipe.

4. Flange connection according to claim 1, wherein the radial formation is formed by applying fibre composite material layer by layer.

5. Flange connection according to claim 1, wherein the radial formation is formed by winding on fibre composite material.

6. Flange connection according to claim 1, wherein the measuring pipe is widened in the widening region in such a way that a flank rising continuously towards the end of the measuring pipe is formed by the widening.

7. Flange connection according to claim 6, wherein the measuring pipe is widened in the widening region with constant pipe wall thickness.

8. Flange connection according to claim 6, wherein the measuring pipe end piece is conically widened in the widening region.

9. Flange connection according to claim 8, wherein the cone angle at the transition between the middle part of the measuring pipe and the widening region has a value between 1° and 45°, in particular between 10° and 40°, preferably between 15° and 35° and particularly preferably between 28° and 32°.

10. Flange connection according to claim 1, wherein the measuring pipe with the widening region is formed entirely or partly from fibre composite material.

11. Flange connection according to claim 1, wherein the measuring pipe with the widening region is formed entirely or partly from metal.

12. Flange connection according to claim 1, wherein the measuring pipe is formed as a metal part and the widening region is formed entirely or partly from fibre composite material.

13. Flange connection according to claim 1, wherein the flange disc on the device side can be pushed in the direction of the end of the measuring pipe onto the rising flank of the widening region.

14. Flange connection according to claim 1, wherein the flange disc on the device side can be pushed onto the rising flank of the widening region by means of an intermediate piece arranged between the flange disc and the widening region.

15. Flange connection according to claim 14, wherein the intermediate piece is of a multipart form.

16. Flange connection according to claim 1, wherein the longitudinal sectional contour of the inner circumferential surface of the flange disc on the device side or of the intermediate piece is adapted to the circumferential contour of the measuring pipe in the widening region.

17. Flange connection according to claim 1, wherein the installed state there is a positive and/or non-positive connection between the flange disc on the device side and the measuring pipe in the widening region or between the intermediate piece (16) and the measuring pipe (6) in the widening region (E).

18. Flange connection according to claim 1, wherein the outer circumferential contour of the measuring pipe in the widening region corresponds in certain regions to a polynomial of the nth degree, or is composed in certain regions of a polynomial of the nth degree, n being an integral number, in particular between 0 and 10, preferably between 0 and 4 and particularly preferably 1 or 2 or 3.

19. Flange connection according to claim 1, wherein the outer circumferential contour of the measuring pipe in the widening region corresponds in certain regions to a polynomial of the nth degree, or is composed in certain regions of a polynomial of the nth degree, n being an integral number, in particular between 0 and −10, preferably between 0 and −4 and particularly preferably −1 or −2 or −3.

20. Flange connection according to claim 1, wherein the end of the measuring pipe is formed as a sealing surface.

21. Flange connection according to claim 1, wherein a sealing ring is attached to the end of the measuring pipe.

22. Flange connection according to claim 1, wherein a second flank, on the pipe end side, of the widening region forms a sealing surface with the end of the pipe.

23. Flange connection according to claim 1, wherein the intermediate piece and/or the flange disc on the device side are temporarily held in their installation position before installation by suitable structural measures.

24. Flange connection according to claim 23, wherein the intermediate piece and/or the flange disc on the device side are temporarily held in their installation position before installation by spots of adhesive and/or mechanical holding aids and/or by wrapping with fibre composite material.

25. Flange connection according to claim 1, with a mating flange on the process pipe side.

26. Flange connection according to claim 1, with a mating flange on the process pipe side of a conventional type of construction.

27. Method for producing a flange connection, in particular for connecting the measuring pipe of a measuring device for fluid substances to a pipeline, the flange connection comprising a flange disc on the device side and a flange disc on the line side, and the flange disc on the device side having an inner circumferential surface and an outer circumferential surface, and it being possible for the pipe wall of the measuring pipe to be formed, at least at the end zones of the pipe, by layers of different materials lying one on top of the other, characterized in that a radially outwardly pointing formation is formed onto the pipe wall of the measuring pipe at least one end zone of the pipe and in that in the installed state axial tensile forces are transmitted from the flange disc to the measuring pipe via the formation.

28. Method according to claim 27, wherein the radial formation is formed as a bead with a flank rising continuously towards the end of the pipe, formed conically or with a hyperbolic longitudinal sectional contour.

29. Method according to claim 27, wherein the formation of the radial formation is carried out as one of the last production steps in the production of the measuring device.

30. Method according to claim 27, wherein the force transmission, an intermediate piece which is in connection with the flank of the radial formation, at least in certain portions, is arranged between the flange disc and the formation.

31. Method according to claim 27, wherein the radial formation is formed by applying fibre composite material layer by layer.

32. Method according to claim 27, wherein the radial formation is formed by winding on fibre composite material.

33. Method according to claim 27, wherein a sealing surface is formed by a second flank, on the pipe end side, of the formation together with the end of the pipe.

34. Method according to claim 27, wherein the intermediate piece and/or the flange disc are temporarily held in their installation position before installation by spots of adhesive and/or mechanical holding aids and/or by wrapping with fibre composite material.
